(19) United States
(12) Patent Application Publication
(10) Pub. No.: US 2003/0114119 A1
(43) Pub. Date: Jun. 19, 2003

(54) Auxiliary apparatus for mobile phone

(76) Inventor: Wen-Kuang Liang, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/015,742

(22) Filed: Dec. 17, 2001

(51) Int. Cl. H04M 1/00

(52) U.S. Cl. 455/90; 455/568; 455/569

(57) ABSTRACT

An auxiliary apparatus comprises a rotating base, a base and a buckling piece with a long arc strip shape. The rotating base is pivoted on a bottom of the base. The bottom surface of the rotating base is adhered on a case of a mobile phone via a twin adhesive. One end of the buckling piece is connected to the base, and another end is buckled on a head of a human being via the arc shape of the buckling piece. The auxiliary apparatus makes the mobile phone firmly fixed aside of an ear of the human being without handholding.

### BACKGROUND OF THE INVENTION

1. Field of the Invention

The present invention is an auxiliary apparatus for mobile phone, especially applied a mobile phone on a head of a human being, and without handholding.

2. Description of the Prior Art

Mobile phone is convenient and active so that it is popular, especially the society under that time is money. Such handy communication tool has brought functions of saving time and high efficiency into full play.

Generally, the modes of mobile phone for carrying are that placing into a handbag or a special bag. While a phone call is coming, user must hold the phone and approach to his ears for talking.

The aforesaid prior manners of using wireless phones cannot avoid that one of hands has to hold the phone, thus no matter in office or car, inconvenience and danger are then happened.

For overcoming the drawbacks, a new device is provided. The device comprises an amplifier, a speaker, a microphone, some wires, etc. The device plays the role without gripping phone by hand, but it consists of plural components and wires, therefore the installment is complicate and hard to be stored up. On the other hand, a gap between microphone and mouse causes echoes, thus user must speak loudly.

### SUMMARY OF THE INVENTION

The main object is to provide an auxiliary apparatus for mobile phone having a function of talking to phone without handholding. The auxiliary apparatus comprises at least one rotating base, one stand and one buckling piece with long arc strip shape. The rotating base is pivoted on a bottom of the stand. A bottom surface of the rotating base is adhered to a case of a mobile phone via twin adhesive. One end of the buckling piece is connected to the stand, and another end of the buckling piece is buckled up a head of a human being via its long arc strip shape. A feature of the buckling piece with flexibility is the channel to firmly fix the mobile phone on a position near the human being ear without hand holding.

The second object is to provide an auxiliary apparatus for mobile phone for fast wearing on and taking off from a head of a human being. The auxiliary apparatus comprises at least one rotating base, one stand and one buckling piece with long arc strip shape, and all three are mechanical components; thus the auxiliary apparatus easily achieves the aforesaid object.

### BRIEF DESCRIPTION OF THE DRAWINGS

FIG. 1 is a top view of an auxiliary apparatus for mobile phone of the present invention.

FIG. 2 is a side view of the auxiliary apparatus for mobile phone of the present invention.

FIG. 3 is a bottom view of the auxiliary apparatus for mobile phone of the present invention.

FIG. 4 is a rear view of the auxiliary apparatus for mobile phone of the present invention.

FIG. 5 shows the auxiliary apparatus installed on a mobile phone.

FIG. 6 is a side view of the auxiliary apparatus installed on a mobile phone.

FIG. 7 shows the buckling piece of the auxiliary apparatus pulled out.

FIG. 8 shows a long arc strip shape of the pulled out buckling piece.

FIG. 9 shows the auxiliary apparatus adhering to a mobile phone via twin adhesive.

FIG. 10 shows a rotating base and a stand molded on a case of a mobile phone.

### DETAILED DESCRIPTION OF THE INVENTION

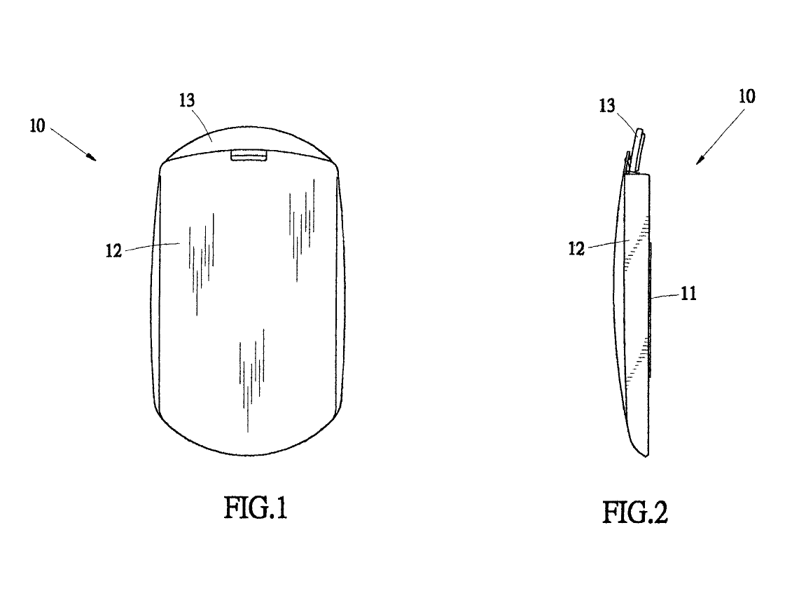

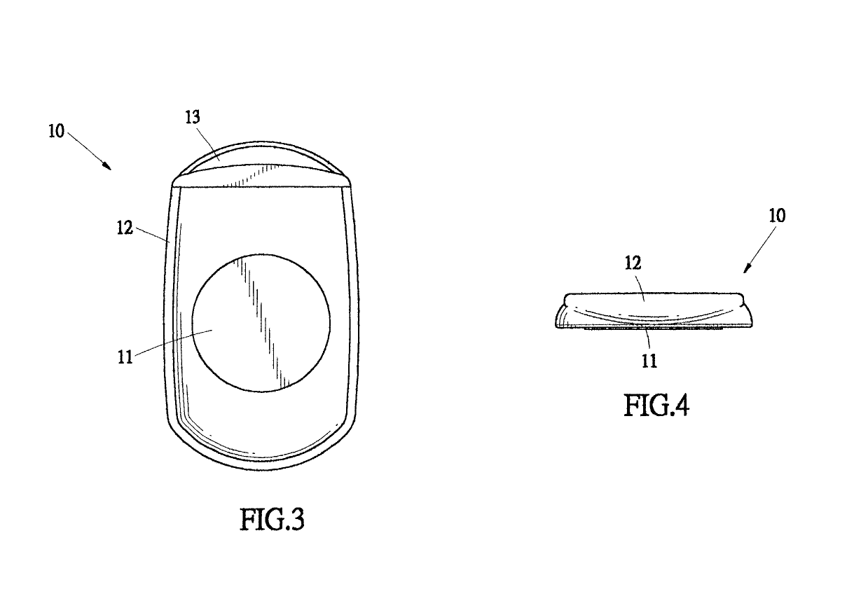

The present invention is an auxiliary apparatus for mobile phone. Please refer to FIGS. 1 to 4. The auxiliary apparatus 10 comprises a rotating base 11, a stand 12 and a buckling piece 13 with long arc strip shape.

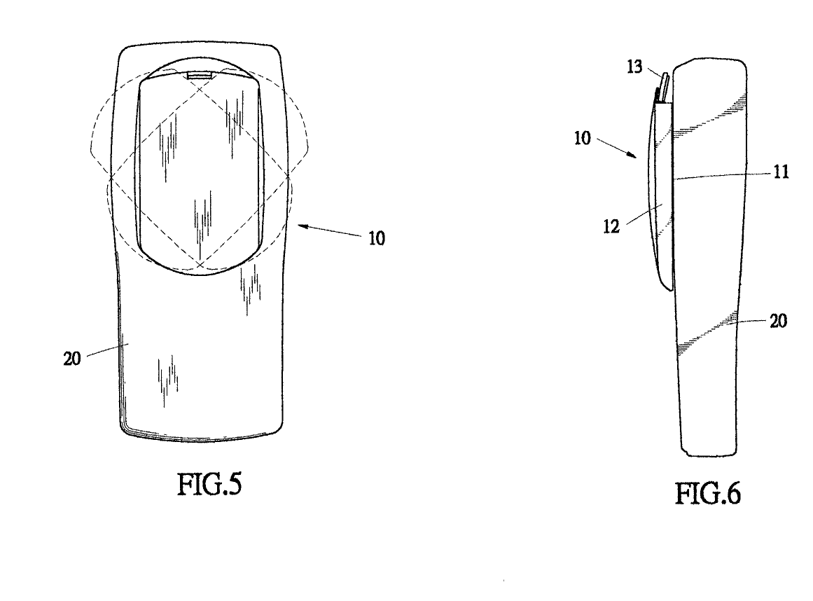

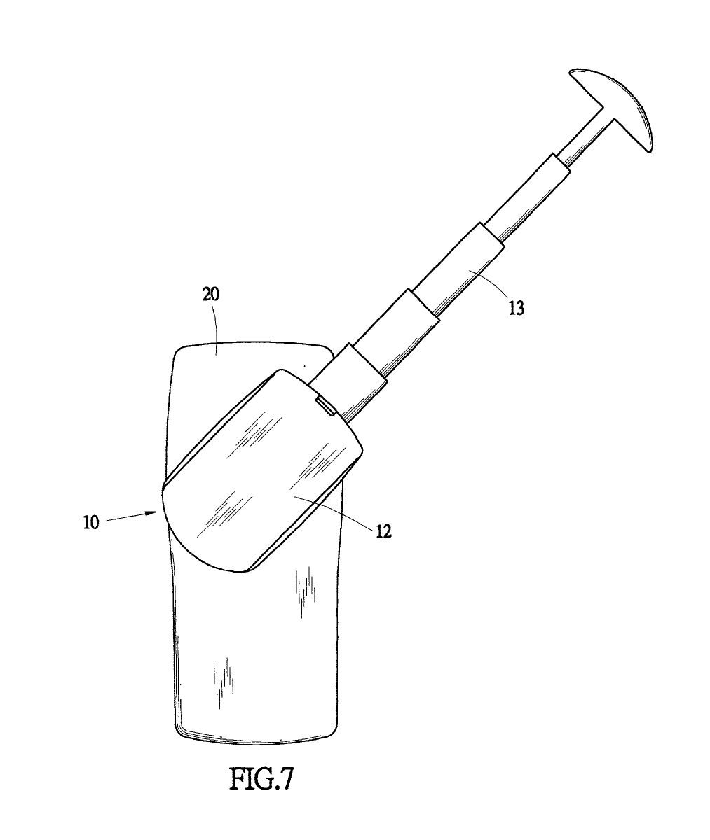

The auxiliary apparatus 10 is installed on a case of a mobile phone 20, as shown in FIGS. 5 and 6. Thus, the auxiliary apparatus 10 may 20 firmly fix the mobile phone 20 on one's head, and the mobile phone 20 is close to whose ear for phone conversation without handholding.

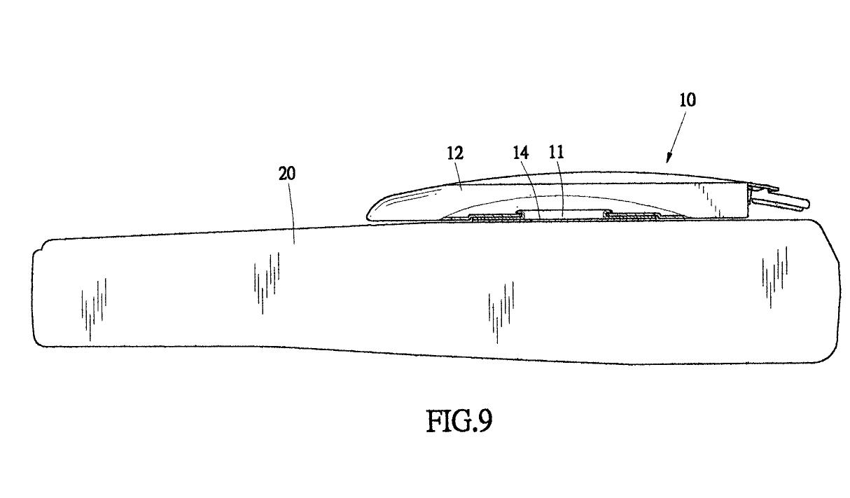

Referring to FIG. 5, the rotating base 11 of the auxiliary apparatus 10 is around and pivoted on a bottom of the stand 12 for being able to rotate a suitable angle. Referring to FIG. 9, a bottom surface of the rotating base 11 is adhered to a case surface of the mobile phone 20 via a twin adhesive 14 for connecting the stand 12 with the mobile phone 20.

In the preferred embodiment, the stand 12 is a hollow type and flat shaped, and its bottom connects to the mobile phone 20 via the rotating base 11. Further, the hollow part of the stand 12 is able to contain the buckling piece 13.

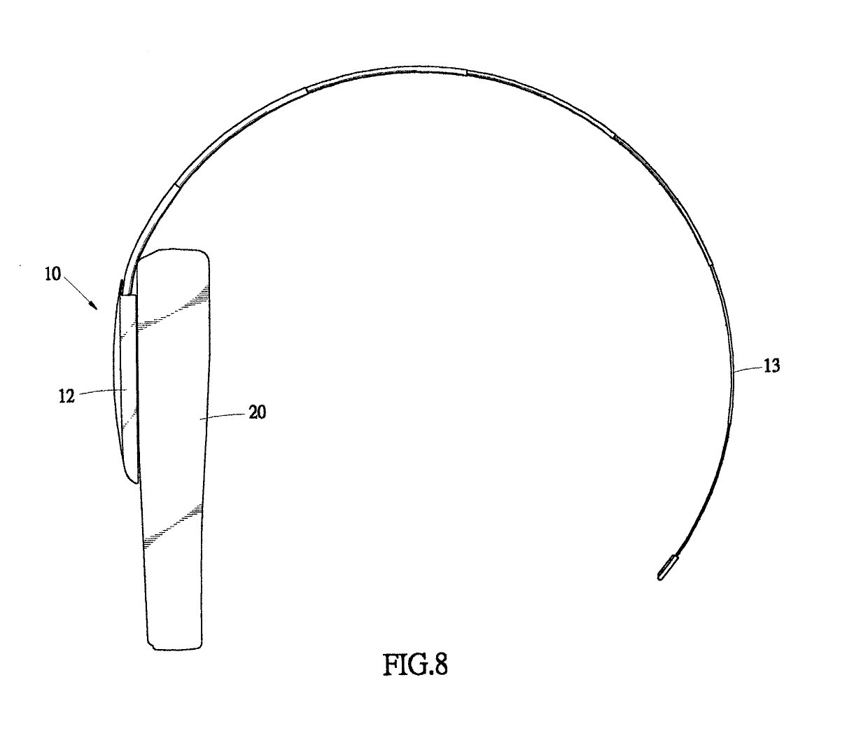

Referring to FIGS. 7 and 8, the buckling piece 13 is extendable, which one end connects to the hollow part of the stand 12. The buckling piece 13 can be hidden in the hollow part of the stand 12. On the other hand, it is extendable to become a long arc strip shape with a function of clamping flexibility to buckle on a head of a human being. Further, the mobile phone 20 is firmly fixed on a position around the user's ear.

The auxiliary apparatus 10 can be adhered on the mobile phone 20 via twin adhesive 14, then incorporate with the rotating base 11, the stand 12 and the buckling piece 13 to fast and firmly fix on the head without handholding.

After finishing talking, the user is convenient to take off the mobile phone 20 from head, and push the buckling piece 13 into the hollow part of the stand 12 for going back to a state of non-use.

As shown in FIG. 9, adopting the twin adhesive 14 to stick the auxiliary apparatus onto the mobile phone 20 is suitable for most kinds of mobile phones in the current marketing.

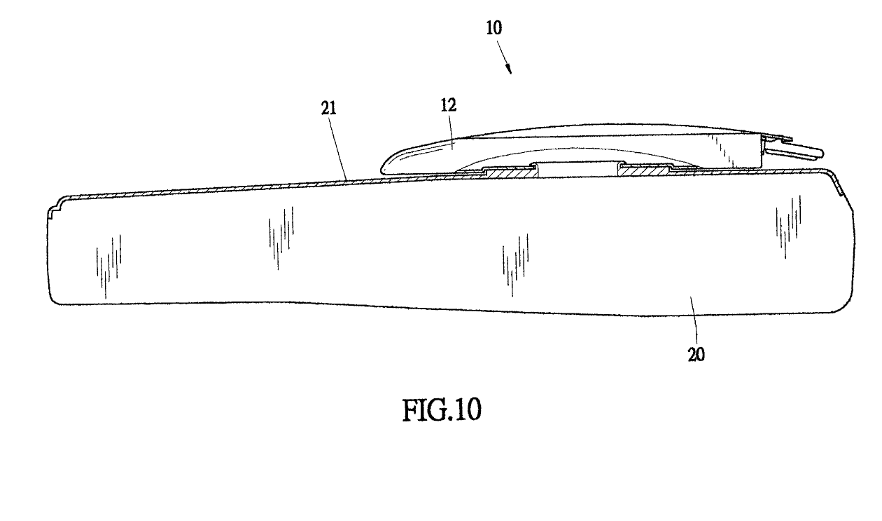

FIG. 10 shows another preferred embodiment of the present invention.

In FIG. 10, the rotating base 11 is directly molded on a case 21 of the mobile phone 20. That is, the stand 12 and the buckling piece 13 are the certain accessories of the mobile phone.

The third embodiment is that the case 21 is provided with a groove. A hook is formed on the top surface of the rotating base 11. The hook incorporates with the groove to be instead of the twin adhesive 14. The design as mentioned above may approach the purpose of the auxiliary apparatus 10 connecting to the mobile phone 20, and its convenience is to easily take apart of the auxiliary apparatus 10 and the mobile phone 20.

The buckling piece 13 for the third embodiment may then be change its original design, which means the function of extendable ability is not a necessary factor, a non-extendable long arc strip structure is the basic requirement of the preferred embodiment for saving cost.

For practical application, the present invention may provide the current mobile phone with features of light, thin, short and small.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. An auxiliary apparatus for mobile phone, which comprises:
a stand being a flat shape and having a hollow part
a rotating base having a round shape and pivoted on a bottom of the stand for rotating a suitable angle; the rotating base being as a media for connecting the bottom of the stand to a mobile phone;
a buckling piece having a long arc strip shape and a function of extendable ability; one end of the buckling piece connecting to the hollow part of the stand; the buckling piece being hidden in the hollow part of the stand and extended to become a long arc strip shape with a function of clamping flexibility;
a bottom surface of the rotating base being adhered on a case surface of the mobile phone via a twin adhesive for connecting the stand to the mobile phone; the buckling piece being firmly fixed on a head of a human being for making that the mobile phone being closely placed aside of a ear of the human being.

2. The auxiliary apparatus for mobile phone as cited in claim 1, wherein, the rotating base is directed molded on the case of the mobile phone.

3. The auxiliary apparatus for mobile phone as cited in claim 1, wherein, the case of the mobile phone is grooved a fillister; a top surface of the rotating base is installed a hook for being instead of the twin adhesive.

4. The auxiliary apparatus for mobile phone as cited in claim 3, wherein, the buckling piece is a non-extendable long arc strip structure.
